(19) United States
(12) Patent Application Publication
(10) Pub. No.: US 2004/0070160 A1
(43) Pub. Date: Apr. 15, 2004

(54) Automatic air suspension control system for vehicle loading

(76) Inventors: Charles E. Eberling, Wellington, OH (US); Gerald E. Rychlik, North Ridgeville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/456,252

(22) Filed: Jun. 6, 2003

Related U.S. Application Data
(60) Provisional application No. 60/386,275, filed on Jun. 6, 2002.

(51) Int. Cl. B60G 11/30

(52) U.S. Cl. 280/124.16

(57) ABSTRACT

An automatic air suspension control system for a tractor trailer includes a system for allowing suspension air pressure to be dumped for the suspension system during a necessary and required loading/unloading of the tractor trailer. The control system includes a transmission device and an receiving device for activating a valve for exhausting the air pressure from a suspension unit.

### RELATED APPLICATIONS

This application claims priority to Provisional Application Serial No. 60/386,275, filed on Jun. 6, 2002 which is hereby fully incorporated by reference.

### FIELD OF THE INVENTION

The present invention relates to an air suspension control system on a commercial vehicle, specifically a trailer truck, for releasing air pressure from the trailer's suspension system. In particular, the invention relates to a transmitter signaling a device to release the air pressure filed in the suspension system.

### BACKGROUND OF THE INVENTION

Many air suspended trailers dump all suspension pressure for loading and unloading a trailer to obtain a stable, consistent height at the loading docks. Landing gear lowered before the suspension system is dumped, or has bottomed, on the trailer can cause damage to the landing gear. In order to park a tractor trailer for loading or unloading, landing gear is released before placing the tractor trailer is placed in park. After the tractor trailer is placed in park, failure to dump the air pressure from the suspension system can cause the trailer landing gear to be damaged as a result of the forward motion caused by the settling of the suspension due to the suspension geometry.

In prior trailer suspension geometry, the suspension air bag pressure must be dumped prior to parking the truck with the trailer. Many suppliers of theses suspension systems have made the system of dumping suspension system pressure automatically when the vehicle is placed in park, rather than having an operator of the vehicle have manual control of the dumping of the suspension pressure. Suppliers of these types of suspensions are wasting air pressure every time the vehicle is placed in park, even though it is not necessary to dump the suspension pressure every time the vehicle is placed in park.

To cause the suspension pressure to be dumped from the trailer supply line prior to the actual park application, expensive high capacity suspension valves are needed. It would be beneficial to have a suspension control system that releases the suspension pressure at the required and necessary times of loading and unloading a trailer in a simple and cost efficient manner.

### SUMMARY OF THE INVENTION

The invention is an automatic air suspension control system on a vehicle. The control system includes an air tank for storing air pressure, an air bag for holding air pressure connected to the air tank, a pressure protection valve connected to the air tank for filling air pressure from the air tank to the air bag, a height control valve connected to the pressure protection valve for controlling the amount of air pressure that fills the air bag, and a latching solenoid between the height control valve and the air bag.

In addition, the invention is a method for releasing air pressure from air bags on a tractor trailer. The method includes placing the truck in reverse gear, transmitting a signal from a programmable logic controller, receiving the signal by an electronic control unit, and releasing air pressure from the air bags.

Further, the invention is a method of releasing air pressure from suspension air bags on a tractor trailer. The method includes driving a tractor trailer through a gate with a transmission device, receiving a signal from the transmission device, and activating a valve to exhaust air pressure from suspension air bags.

### BRIEF DESCRIPTION OF THE DRAWINGS

The following is a brief description of each drawing used to describe the present invention, and thus, are being presented for illustrative purposes only and should not be limited to the scope of the present invention, wherein:

FIG. 1 shows the configuration of a first embodiment of the automatic air suspension control system for vehicle loading.

FIG. 2 shows the configuration of a second embodiment of the automatic air suspension control system for vehicle loading.

### DETAILED DESCRIPTION OF THE INVENTION

As will be described, the exemplary embodiment of the present invention overcomes the problem created by unnecessarily releasing suspension air pressure when a tractor-trailer vehicle is driving in reverse gear and/or parking the vehicle by providing a suspension system wherein a valve is activated for releasing suspension air pressure only during a required condition. The invention includes a transmitter and electronic control unit and, as described, the design of the exemplary embodiment of this invention provides multiple means by which a signal may be transmitted to the valve.

The automatic air suspension control system 10 is designed to dump suspension air pressure as a vehicle enters a cargo loading and unloading terminal and to refill the suspension air pressure as the vehicle exits the cargo loading and unloading terminal. The automatic air suspension control system includes latching solenoids 20, special I/O boards on an anti-lock brake system (ABS) electronic control unit (ECU) 30, a means for receiving a signal 40, a means for transmitting a signal 50, and a means for controlling the latching solenoids.

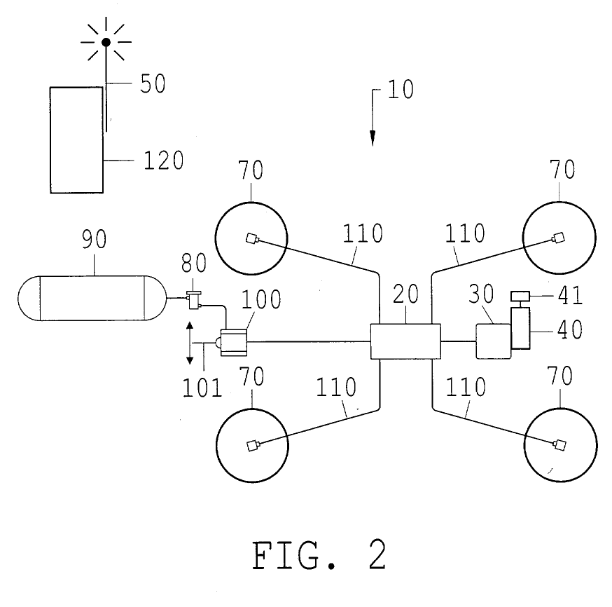

In the automatic air suspension control system 10, an air tank 90 stores air pressure to fill a suspension unit, such as air bags 70 or air bladders, with air pressure. In the preferred embodiment of FIG. 2, air bags 70, preferably four air bags, are used in the suspension system. The air bags 70 are used to support a trailer of a commercial vehicle on an axle.

A pressure protection valve 80 is connected to the air tank 90 for filling the air bags 70 with the air pressure held in the air tank 90. A height control valve 100, between the pressure protection valve 80 and the air bags 70, controls the amount of air pressure that fills the air bags 70. The height control valve contains a height control arm 101 for maintaining the recommended suspension height of the specific trailer. If the air suspension system fails or if there is a failure downstream from the air suspension system, the air tank 90 will retain air pressure for other functions.

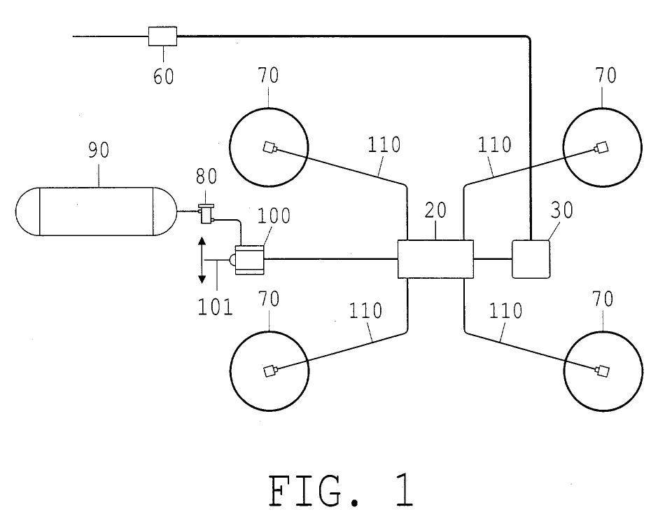

A dump valve 20 is connected to each air bag 70. There could be one central dump valve 20, as shown in FIGS. 1 and 2, wherein each air bag is connected to the central dump valve 20, or one dump valve for every air bag. Electrically activated by the ECU 30, the dump valve 20 will exhaust the air pressure from the air bags 70. The size of the suspension dump valve 20 and the size of the lines 110 from the air bags 70 used to dump the air pressure determine the rate the air pressure will be dumped from the air bags 70.

The invention has the ability to receive a radio, magnetic, or other type of signal from a transmission device 50 external from the vehicle and located at a cargo loading/unloading terminal or gate 120. The signal will occur when the vehicle is driven near or passed the location of the transmission device 50, such as, for example, but not limited to the gate of the delivery/pick-up area or the specific cargo terminal. The electrical transmitter 50 is at the gate 120 and is constantly on causing the ECU 30 to change state every time the ECU 30 comes in close proximity with the transmission device 50. The ECU 30 contains a receiver 40, or similar device, with an antenna 41 for receiving the transmission signal, either radio, magnetic, or other, from the transmission device 50.

The invention has a means of transmitting a signal 50 at the cargo loading and unloading terminal 120 with a transmitter or the like, a means for receiving the signal 40 located at the trailer with a receiver, antenna, or the like, and a means for controlling a latching solenoid 20. The means for transmitting and receiving the signal may be accomplished by, but not limited to, laser, radio, magnetic, sonar, radar, or infrared transmission or receiving devices. The receiver can be located on the tractor or the trailer, but preferably on the tractor.

The latching solenoid 20, which could be pneumatically or magnetically latched, but not limited to, is between the height control valve 100 and the air bags 70. The latching solenoid 20 could be a suspension dump valve, or control the suspension dump valve. The latching solenoid 20 stays in the position it is actuated to, until it is actuated to another position. Thus it is not affected by a loss of vehicle power. Therefore, the latching solenoid 20 does not need power to stay in the current state, either open or closed, nor will the latching solenoid 20 lose air suspension power.

When the ECU 30 receives the transmission signal as the tractor trailer passes through the gate 120, the ECU 30 activates the dump control valve 20 to an open state to release the air pressure within the suspension air bags 70. The tractor trailer is either loaded or unloaded at the terminal. After this process, the tractor trailer leaves the loading and unloading area and passes through the gate once again wherein the ECU 30 receives another signal from the transmission device 50 in which the ECU 30 activates the dump valve 20 to change state to a closed position. The closing of the dump valve 20 allows the suspension air bags 70 to be filled again.

An alternative embodiment, shown in FIG. 1, of the invention dumps and refills the suspension air pressure by receiving an internal signal from a programmable logic controller (PLC) 60 directly on the vehicle. The dumping of the suspension air pressure would be accomplished by using a signal from a transmission PLC 60 every time the vehicle transmission is placed in reverse gear, for approaching a loading and unloading area, and the refilling of the suspension air pressure would be accomplished by using a signal from the PLC once the vehicle exceeded a predetermined speed in the forward direction, for pulling away from the loading and unloading area. The PLC 60 sends a signal to the dump valve 20, therefore activating the dump valve 20 to exhaust the air pressure from the air bags 70.

The foregoing description is, at present, considered to be preferred embodiments of the present invention. However, it is contemplated that various changes and modifications Therefore, the foregoing description is intended to cover all such changes and modifications encompassed within the spirit and scope of the present invention, including all equivalent aspects.

It is claimed:

1. An automatic air suspension control system on a vehicle comprising:
an air tank for storing air pressure;
an air bag for holding air pressure connected to said air tank;
a pressure protection valve connected to said air tank for filling air pressure from said air tank to said air bag;
a height control valve connected to said pressure protection valve for controlling the amount of air pressure that fills said air bag;
a latching solenoid between said height control valve and said air bag.

2. The automatic air suspension control system according to claim 1 further comprising a suspension dump valve for exhausting air pressure from said air bag controlled by said latching solenoid.

3. The automatic air suspension control system according to claim 1 wherein said latching solenoid is a suspension dump valve for releasing air pressure from said air bag.

4. The automatic air suspension control system according to claim 1 further comprising a means for transmitting a signal to said air suspension control system for activating an exhaust condition of air pressure from said air bag and a means for receiving a signal from said means for transmitting a signal.

5. The automatic air suspension control system according to claim 4 wherein said means for transmitting a signal is external from said vehicle.

6. The automatic air suspension control system according to claim 4 wherein said means for transmitting a signal is attached to said vehicle.

7. The automatic air suspension controls system according to claim 4 wherein said means for transmitting a signal is a transmitter located at a cargo loading and unloading terminal.

8. The automatic air suspension control system according to claim 4 wherein said means for transmitting a signal is a programmable logic controller for transmitting a signal to said means for receiving a signal when said vehicle is placed in reverse gear, wherein said means for receiving a signal is an electronic control unit.

9. The automatic air suspension control system according to claim 4 wherein said means for receiving a signal is an antenna, wherein said antenna is attached to an electronic control unit.

10. A method for releasing air pressure from air bags on a tractor trailer comprising the steps of:
placing said truck in reverse gear;
transmitting a signal from a programmable logic controller;
receiving said signal by an electronic control unit; and
releasing air pressure from said air bags.

11. A method of releasing air pressure from suspension air bags on a tractor trailer comprising the steps of:
driving a tractor trailer through a gate with a transmission device;
receiving a signal from said transmission device; and
activating a valve to exhaust air pressure from suspension air bags.
